(19) United States
(12) Patent Application Publication
(10) Pub. No.: US 2008/0290704 A1
(43) Pub. Date: Nov. 27, 2008

(54) SEAT FOR MOTORCYCLES

(76) Inventor: Randy Chipkar, Mississauga (CA)

Correspondence Address: YOUNG & BASILE, P.C., 3001 WEST BIG BEAVER ROAD, SUITE 624, TROY, MI, 48084, US

(21) Appl. No.: 12/131,578

(22) Filed: Jun. 2, 2008

Related U.S. Application Data
(63) Continuation of application No. 11/604,443, filed on Nov. 27, 2006.
(60) Provisional application No. 60/741,603, filed on Dec. 2, 2005.

(51) Int. Cl. B62J 1/00

(52) U.S. Cl. 297/195.13

(57) ABSTRACT

An improved seat is disclosed. The seat is of the type for interchangeable use on internal combustion engine motorcycles. The improvement consists of magnetically soft material secured internally within the seat between its frame shell and its cushion to, in use, provide protection for a motorcyclist's groin from near field extremely low frequency magnetic fields produced by electrical components located immediately beneath the seat's base when installed on the motorcycle. The present invention provides a relatively cost effective seat replacement option for health minded or electrosensitive motorcycle consumers who want to reduce groin close exposure to motorcycle generated magnetic fields.

### RELATED APPLICATIONS

This application is a Continuation-In-Part application of U.S. patent application Ser. No. 11/604,443, filed Nov. 27, 2006 under attorney docket no. MBT-177-B, currently pending, which claims priority from a provisional application, U.S. Application Ser. No. 60/741,603, filed under attorney docket no. MBT-177-A on Dec. 2, 2005. The entire contents of both applications are incorporated herein by reference.

### FIELD OF THE INVENTION

The present invention relates to the field of accessories for internal combustion engine motorcycles including interchangeable seats.

### BACKGROUND

Although opinions vary widely, many persons feel that certain adverse health effects in the general population can be associated with extended exposure to electromagnetic energy in the form of electromagnetic fields (EMFs), waves, etc. One perceived risk relates to the suppression of melatonin production, which is a natural anti-cancer growth hormone.

A great deal of attention has in recent years been directed to wireless cellular telephones, by virtue of the electromagnetic exposure associated with the high frequency transmissions which emanate from such devices. Laptop computers have also become objects of recent heightened concern.

As well, some experts are now of the opinion that certain people are more sensitive than others to the magnetic fields affiliated with current induced electromagnetic fields. Specifically, some experts believe that certain people suffer from electrical-sensitivity (ES) and/or electromagnetic hyper-sensitivity (EHS), which causes these people to experience symptoms such as fatigue, headaches, weakness and general discomfort.

Prior designs have included various electromagnetic shielding for biological concerns. Known prior designs having included shielding apparatus which have been concerned with human exposure to higher electromagnetic frequency propagations which can experience signal bounce from conventional metals. Current induced extremely low frequency (ELF) magnetic fields encompass their source and can penetrate through conventional metals and materials.

The present invention addresses groin exposure to current induced near source ELF magnetic fields of generally less than 300 Hz produced by electrical systems affiliated with internal combustion engine (ICE) motorcycles.

### SUMMARY

Modern day ICE motorcycles consist of increasing electrical demands. Many incorporate electrical components very close to and beneath the seat frame base (within approximately 6″) as it is away from the heat of the engine.

The preferred embodiment of the invention is an improved seat of the type having a frame and a cushion and being for interchangeable use on preferably ICE motorcycles, where immediately beneath the seat's base, when installed on the motorcycle, electrical components exist and are producing extremely low frequency magnetic fields during use. The improvement includes a layer of magnetically soft material, secured internally within the seat itself, between its frame shell and cushion, for protection of the motorcyclist's groin from said magnetic field exposure during motorcycle use.

For effective magnetic field attenuation the plate shielding needs to be situated fairly close to the groin/prostate and provide substantial coverage of the related electrical sources that are producing the fields. Even a few inches drop in the shielding plate, such as adhering to an area beneath or below the seat's base, can compromise its effectiveness for groin/prostate magnetic field protection.

An object of the invention is to provide effective and substantial ELF magnetic field attenuation for the groin and seat area. Effective attenuation is evident in the near shield zone opposite from the magnetic field source being shielding. The closest possible shield position to the groin/prostate is advantageous and is accomplished with seat internal shield implementation.

Many interchangeable seats for use on ICE motorcycles have seat frames that rise up and are concave, thereby allowing a closer to groin shield orientation necessary for most effective near shield groin/prostate protection. The “rise up” usually is to accommodate electrical cables and components fitted immediately beneath the seat underside.

On an ICE motorcycle, access is necessary to the electrical component area located underneath the seat. Any “fixed” shielding applied to this area would be cumbersome and impractical.

An object of the present invention is to provide protection for the magnetically soft shielding by positioning the material internally within the seat itself. Material protection is important as even the tiniest perforation, hole, or gap could compromise magnetic field attenuation.

An object of the invention is to protect the shielding material as much as possible from any engine heat whatsoever by positioning the material internally within the seat itself. Excessive heat can eventually have an effect on the shielding properties or characteristics of some previously annealed magnetically soft materials.

An object of the present invention is to provide a relatively weight efficient groin/prostate magnetic field shielding accessory, for ICE motorcycles, by way of a seat as magnetically soft shielding can be weight bearing. This is in comparison to shielding larger fixed enclosures of great weight increase to the motorcycle which would be detrimental to fuel economy.

Another object of the present invention is to provide a uniform broad surface area for the magnetically soft shielding as this is important for effective uniform magnetic field attenuation. The internal seat shield installation is relatively practical and economical as it does not encounter the complexity of an irregular seat underside or mounting hardware interference.

Another object of the invention is to provide an optimal groin/prostate magnetic field shielding accessory by way of an ICE motorcycle seat prefabricated in factory for cost effective simple implementation of shielding during seat construction.

Another object of the invention is to provide a cost effective consumer option of convenient simple seat replacement for effectively reducing groin/prostate excessive ELF magnetic field exposure on ICE motorcycles.

Other advantages, features and characteristics of the present invention, as well as methods of operation and functions of the related elements of the structure, and the combination of parts and economies of manufacture, will become more apparent upon consideration of the following detailed description with reference to the accompanying drawings, the latter being briefly described herein below.

### BRIEF DESCRIPTION OF THE DRAWINGS

FIG. 1 shows a perspective view of a completed interchangeable seat according to a preferred embodiment of the invention; and

FIG. 2 is an exploded perspective view of the seat of FIG. 1

### DETAILED DESCRIPTION

An improvement in the seat 27 resides in the incorporation of a sheet or layer of magnetically soft material 24 between the seat's frame shell 23 and its cushion 25. The sheet material 24 illustrated takes the form of a 0.01 inches thick sheet of the alloy sold under the trade-mark MUMETAL® by Magnetic Shield Corporation, of Illinois. This particular manufactured material is a hydrogen annealed, high nickel bearing alloy, composed substantially of 80% nickel, 4.4% molybdenum and iron. It is magnetically soft and highly effective for attenuating various magnetic fields of AC and DC origin. This is in sharp contrast to conventional materials used for motorcycle seat construction, which are basically transparent to the extremely penetrating nature of ELF magnetic fields. The sheet 24 is sufficiently thin to be cut and formed, yet relatively durable.

During seat construction, magnetically soft material 24 is installed onto the top of a seat frame shell 23. Using metal shears the magnetically soft material is snipped into shapes or strips that would accommodate a uniform implementation onto the seat frame shell. The segments are positioned to slightly overlap each other ensuring a tight or gapless shield formation over top of the seat frame shell. Seam overlaps of approximately ¼ inch would be appropriate ensuring no gaps or cracks at all. The shielding is to extend to the full maximum periphery of the seat frame shell including the front narrow nose area. The segments are then adhered to the seat frame shell using adhesive or silicone. During the shield formation heat must not be used in any way, such as welding, as it can affect the properties of some magnetically soft alloy materials that have been previously annealed. Conventional seat construction now resumes with the foam padding 25 adhered directly onto the shielding 24. The leather or vinyl exterior seat covering 26 is then applied thus producing the final seat product 27.

Surprisingly, use of this improved seat 27 on a motorcycle dramatically reduces the extent to which the groin/prostate of a rider operator of said motorcycle is exposed to ELF magnetic fields at normal operating conditions.

Measurements in the seat area of many stock production motorcycles of today and yesteryear surprisingly reveal the presence of significant ELF magnetic fields in the form of an irregular type of EMF oscillating within the ELF bandwith of 30-300 Hz. From stationary idling to increasing normal speeds, the various EMF readings increase dramatically, when read by a single axis AC Gauss meter. For example, a 2005 cruiser type, V-twin stock production motorcycle reveals EMF readings of approximately 15 milliGauss (mG) in the seat area during stationary idling. The same motorcycle when traveling reveals a gradual increase in the seat area EMF strength. When traveling at approximately 25 mph, during normal RPM's, the EMF readings surprisingly displayed an approximate range of 138-142 mG. With the improved seat 27 of the preferred embodiment installed in place of the stock seat, under the same conditions, field strength readings were attenuated to approximately 1.1 mG during stationary idling and to approximately 14 mG for the 25 mph motion.

For greater certainty, it should be understood that the location where the measurements above were taken roughly corresponded to the position of the pelvis and sensitive vital organs and glands in the groin area of a seated rider.

Similar measurements in the seat area of many motorcycles of different brand, model, year, engine size, etc., reveal various EMF strengths, some as high as 195 mG.

Without intending to be bound by theory, it is believed that sources of ELF EMF magnetic field emissions on the ICE motorcycles tested are the electrical system and spark generating system which uses electromagnetic fields to produce high voltage electricity for transmission to the spark plugs. Various types of electromagnetic energies are emitted from various electrical components of an ICE motorcycle including ELF magnetic near fields from a type of alternating/oscillating current. The utility of the improved interchangeable seat flows from its internal strategic incorporation of magnetically soft material between the groin of the rider and the ELF magnetic near field source components, modules and cables located directly underneath, within approximately 6″ from, the seat's base when installed in position on an ICE motorcycle.

Many motorcycle models and designs contain electrical system components, including the battery and electrical cables, immediately beneath the seat of the rider where they are away from the heat of the engine. In motorcycles of this type tested, use of the improved seat 27 resulted in a consistent and substantial attenuation of EMF readings in the groin area, typically by about 90%.

Motorcyclists concerned about EMF groin exposure would benefit from this improved seat by its cost effective dramatic attenuation of ELF EMF magnetic fields.

Although the seat examples herein relate to rider operator seats, the shielding could also extend to passenger areas also.

As well, interchangeable seats of varied style and having varied mounting hardware arrangements can be provided, so as to permit seats according to the present invention to be conveniently mounted on any chosen motorcycle without alteration to the mounting hardware thereof or impact upon the aesthetics or ride comfort.

As well, whereas the preferred embodiment illustrated references the use of MUMETAL® alloy, other alloys can be substituted therefor. There are many different brands of specifically manufactured, relatively high nickel bearing, magnetically soft alloys available in different thickness from various companies. Further brand or trade name examples are HIPERNOM® as sold by Carpenter Technology Corporation of Pennsylvania, MAGNIFER® 7904 as sold by EFI Corporation of New Jersey, CO-NETIC™ also sold by the Magnetic Shield Corporation of Illinois, etc. All of these alloys are substantially nickel (75-85%), molybdenum (3-6%) and iron, and provide effective electromagnetic field attenuation. LESS EMF Inc. of Albany sells another recently new magnetically soft effective product called GIRON®. This innovative material is also advantageous as it is very pliable and flexible for accommodating the curves affiliated with an ICE motorcycle seat's internal shell top surface.

Furthermore, the sheet or layer may be substituted for a compound material such as, wire weaves, laminated composites, etc. designed specifically for ELF magnetic field attenuation. As well, various layers of different thickness may be used to tailor attenuation, and the layers may be separated by electrically conductive or non-conductive material.

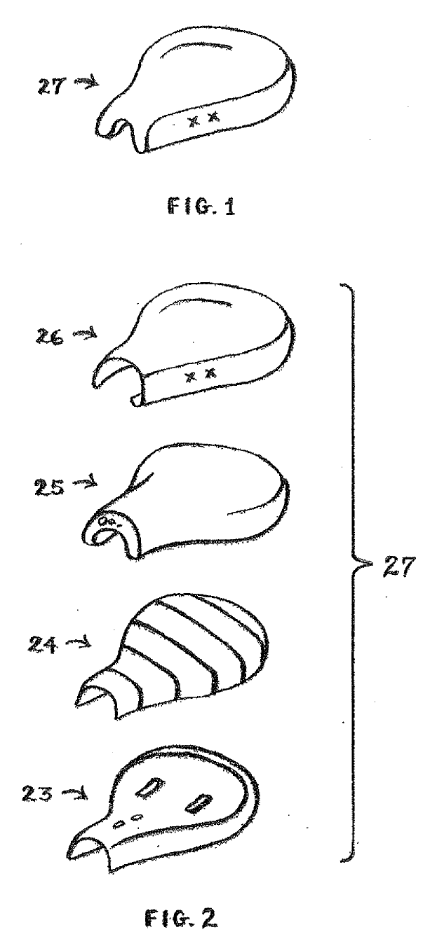

As well, whereas FIG. 1 shows an ICE motorcycle seat, persons of ordinary skill in the art will readily appreciate that seats of this structure could be employed in use with other hybrid ICE motorcycle type vehicles such as ATV's (all-terrain vehicles), trikes, etc.

Moreover, whereas the description includes reference to an electrical spark generating system, it is contemplated that the invention extends to shielding other ELF magnetic field producing structures, components, modules, cables, direct ignition systems, multiple coils, control modules, relays, batteries, etc. that may be found directly beneath the seat specifically on various ICE motorcycles.

Further, whereas the magnetically soft material is indicated herein to form an added layer within an otherwise conventional seat, the magnetically soft material could be substituted for other materials in an otherwise conventional ICE motorcycle seat, i.e. the shielding material could form the actual frame or shell of an improved interchangeable seat for ICE motorcycles.

As well, whereas specific shield mounting techniques such as adhesive or silicone is described it will be understood that modifications thereto could be made.

It will be understood that these modifications, and others which may be apparent to persons of ordinary skill in the art, may be made without departing from the spirit or scope of the invention. Accordingly, the scope of the present invention should be understood as being limited only by the claims appended hereto, purposively construed.

In the previous description, and in the following claims, the term “shielding” should be understood to encompass ELF magnetic field deflection, re-direction, absorption, reduction, attenuation, etc.

As well, in the previous description and in the following claims, the terms “electrical system” and “electrical components” of the ICE motorcycle vehicle should be understood to encompass, inter alia, its battery, battery cables, modules, relays, etc.

The intensity or strength of current induced ELF magnetic fields rapidly diminishes with distance from their source. On ICE motorcycles, concern flowing from the teachings of the present invention resides in current induced ELF magnetic field sources that are located within approximately 6″ from beneath the seat wherein relatively strong near fields can invade the groin area of an operator; without intending to be bound by theory, seats according to the present invention are believed to be advantageously deployed in such circumstances.

What is claimed is:

1. An improved seat of the type having a frame and a cushion and being for interchangeable use on an internal combustion engine motorcycle, wherein immediately beneath the seat's base, when installed on the motorcycle, electrical components exist and are producing extremely low frequency magnetic fields during use, the improvement comprising:
a layer of magnetically soft material, secured internally within the seat, between the frame and cushion, for protection of the groin of an operator of said motorcycle from said magnetic near field exposure during use.

2. A seat according to claim 1 where the extremely low frequency magnetic fields are less than 300 Hz.
